(19) United States
(12) Patent Application Publication
(10) Pub. No.: US 2021/0285490 A1
(43) Pub. Date: Sep. 16, 2021

(54) BEARING FOR A CRUSHER, AND CRUSHER

(71) Applicants: thyssenkrupp Industrial Solutions AG, Essen (DE); thyssenkrupp AG, Essen (DE)

(72) Inventors: Timo BISCHOF, Münster (DE); David SUDMANN, Münster (DE); Thomas HAGEMANN, Clausthal-Zellerfeld (DE); Maximilian PRÖLSS, Clausthal-Zellerfeld (DE)

(73) Assignees: thyssenkrupp Industrial Solutions AG, Essen (DE); thyssenkrupp AG, Essen (DE)

(21) Appl. No.: 16/345,035

(22) PCT Filed: Dec. 13, 2017
(86) PCT No.: PCT/EP2017/082528

§ 371 Date: Apr. 25, 2019

(30) Foreign Application Priority Data
Dec. 21, 2016 (DE) 10 2016 125 248.4

(51) Int. Cl. F16C 33/10; B02C 2/04

(52) U.S. Cl. CPC F16C 33/1055; F16C 2322/00; B02C 2/04

(57) ABSTRACT

A bearing for a crusher, in particular for a gyratory crusher or cone crusher, may include a housing, an eccentric bush that is mounted in the housing such that the eccentric bush can be rotated about an axle, a bushing that is disposed between the housing and the eccentric bush, and a lubricant line for supplying the bushing with lubricant that extends into the eccentric bush. The lubricant line may extend along an axial direction within a wall of the eccentric bush. An outer side of the eccentric bush may have an outlet opening for the lubricant line, with the outlet opening being directed onto the bushing.

### PRIOR ART

The invention relates to a bearing for a crusher and to a crusher, in particular a cone crusher or gyratory crusher. Crushers of this type are known, for example, from document EP 1 711 266 B1 and serve for the comminution of rocks or minerals into smaller particle sizes. Here, the bearing is provided to bring about a tumbling movement of a crusher cone with respect to the crusher casing, as a result of which an annular gap which constantly opens and closes is configured between the crusher cone and the crusher casing, via which annular gap rocks can be received and broken up. In order to realize the tumbling movement, the bearing correspondingly comprises an eccentric bush which rotates about an axle. Here, the eccentric bush is surrounded at least partially by a bearing bush or bushing which is let into a housing.

In overload situations, brought about by way of constituent parts in the rock volume to be crushed which can be crushed in a comparatively difficult manner or cannot be crushed, damage of the bearing can occur. The consequences are expensive repairs and undesired down times of the crusher.

### DISCLOSURE OF THE INVENTION

It is an object of the present invention to provide a bearing for a crusher, it being possible for the bearing to be subjected over a long time to high loads, in particular to overload situations.

The present invention achieves the object by way of a bearing for a crusher, in particular for a gyratory crusher or cone crusher, the bearing having
a housing,
an eccentric bush which is mounted in the housing such that it can be rotated about an axle, and
a bushing which is arranged between the housing and the eccentric bush, a lubricant line for supplying the bushing with lubricant being let into the eccentric bush.

In comparison with the bearings which are known from the prior art, the lubricant line is let into the rotating eccentric bush and not (as customary in the prior art) into the housing or into the bushing. This has a positive effect on the load-bearing capability of the bushing and therefore on the load-bearing capability of the overall bearing in so far as an effective load-bearing surface area of the bushing can be increased, since a bore which reduces the load-bearing surface area is no longer required in the bushing for the lubricant line. A sufficient supply of a lubricant film to the bushing and the eccentric bush can be ensured at the same time via the lubricant line in the eccentric bush.

The bearing is preferably a plain bearing. Furthermore, it is preferably provided that the lubricant line is arranged within a wall which forms the eccentric bush. In particular, the lubricant line is configured as a bore, or as a blind bore, at the end of which lies a transverse channel with an outlet opening. Furthermore, it is conceivable that the lubricant line extends in the axial direction or in a direction which runs parallel to the axle as far as the center of the bearing, as viewed in the axial direction. It is also conceivable that, in the installed state in the crusher, the lubricant line is arranged above said center and gravity is also utilized to distribute the lubricant between the eccentric bush and the bearing bush. The lubricant is preferably an oil or a lubricant oil. Furthermore, it is preferably provided that the lubricant is introduced from below into the lubricant line and is conveyed to the outlet opening counter to gravity.

Advantageous refinements and developments of the invention can be gathered from the sub-claims and the description with reference to the drawings.

It is provided in accordance with a further embodiment of the present invention that the lubricant line extends along an axial direction within a wall of the eccentric bush. It is also conceivable that the lubricant line extends in a spiral-shaped manner in the wall. An axially oriented lubricant line can be realized most simply, however, and guarantees a feed which is as direct as possible into the desired region.

It is provided in accordance with a further embodiment of the present invention that the outlet opening is spatially delimited in the circulating direction. As a result, the outlet opening is guided along an inner side of the bushing during operation of the crusher and always wets a part region of said inner side. In particular, during its circulation, the outlet opening supplies regions of the bushing with fresh lubricant.

It is provided in accordance with a further embodiment of the present invention that the position of the outlet opening is oriented in such a way that the outlet opening is positioned in a leading manner at a predefined angle in the rotational direction of the bearing with respect to a load region, in particular a current load region, of the crusher or the bushing. Here, the load region corresponds to that region on the bushing which is loaded to the greatest extent during the tumbling movement of the crusher cone. As a result, the load region can advantageously be supplied sufficiently with fresh lubricant. This leads to an improved lubricating film, which ultimately also has a positive effect on the reliability of the bearing system.

It is provided in accordance with a further embodiment of the present invention that the predefined angle is less than 200°, preferably less than 160°, particularly preferably less than 120°.

It is provided in accordance with a further embodiment of the present invention that the eccentric bush has a recess in the region of the outlet opening for configuring a collecting point for the lubricant. Said collecting point can ensure a distribution as far as possible over the full surface area, in particular in the axial direction, of the lubricant between the bearing bush and the eccentric bush. Here, the outlet opening and the recess form, in particular, a hydrostatic pocket.

It is provided in accordance with a further embodiment of the present invention that the recess is delimited on both sides in the axial direction in order to throttle the lubricant supply. Here, an eccentric insert is preferably provided which is arranged between the axle and the eccentric bush. In order to guide the lubricant distribution or the oil flow homogeneously along the bushing and the eccentric insert, the eccentric insert is throttled, in particular, in order to generate a homogeneous oil pressure for the eccentric insert, the axle and the bushing. Furthermore, a lubricant feed line in the eccentric insert is delimited in the axial direction, in particular toward the top, with the result that a throttling action can be realized and the supply of the hydrostatic pocket with lubricant can be ensured. The consequence is a homogeneous lubricant supply of the two bearings.

It is provided in accordance with a further embodiment of the present invention that the bearing has a means for conveying the lubricant in the lubricant line. With the aid of said means, the lubricant can preferably be loaded with pressure in such a way that an uninterrupted supply with the lubricant can be ensured. The means is, for example, a pump.

A further subject matter of the present invention is a crusher having a bearing according to the invention.

Further details, features and advantages of the invention result from the drawings and from the following description of preferred embodiments using the drawings. Here, the drawings illustrate merely exemplary embodiments of the invention which do not restrict the concept of the invention.

### BRIEF DESCRIPTION OF THE FIGURES

FIG. 1 shows a bearing for a crusher in accordance with one exemplary embodiment of the present invention along a sectional plane which runs parallel to the axial direction.

FIG. 2 shows a bearing for a crusher in accordance with the exemplary embodiment of the present invention from FIG. 1 along a sectional plane which runs perpendicularly with respect to the axial direction.

### EMBODIMENTS OF THE INVENTION

In the various figures, identical parts are always provided with the same designations and will therefore as a rule also be named or mentioned only once in each case.

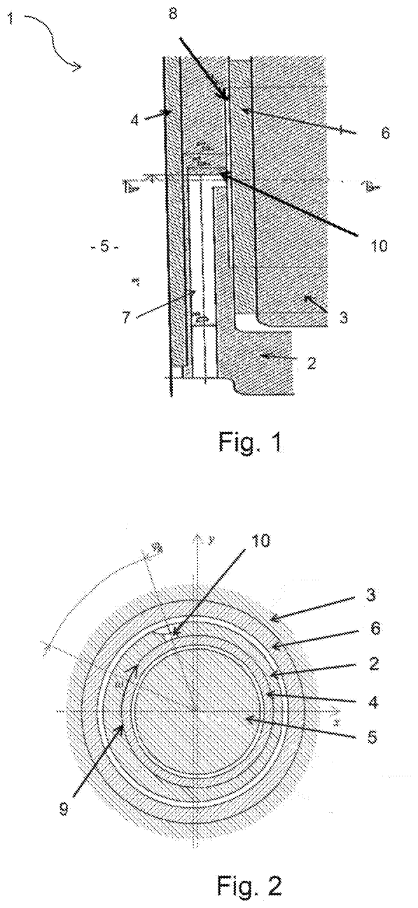

FIG. 1 shows a bearing 1, in particular a plain bearing, for a crusher in accordance with one exemplary embodiment of the present invention in a sectional plane which runs parallel to the axial direction. A crusher is fundamentally to be understood to mean a machine which is provided for the comminution of lumpy material, in particular rocks, to form smaller particle sizes. In particular, it is a cone crusher or gyratory crusher. Here, the comminution takes place in an annular gap which opens and closes in a circulating manner between a crusher casing (not shown) and a crusher cone (not shown). Here, the opening and closing of the annular gap take place at the same time on opposite sides of a crushing space. In order to realize the relative movement between the crusher casing and the crusher cone, which relative movement is responsible for the configuration of opening and closing of the annular gap, it is provided that the bearing 1 has an eccentric bush 2, in order to cause a tumbling movement of the crusher cone with respect to the crusher casing, which tumbling movement is predefined by an eccentric insert. Furthermore, the bearing 1 comprises a housing 3 and a bushing 6 which is arranged between the housing 3 and the eccentric bush 2, the bushing 6 and the housing 3 being fixed. In the embodiment which is shown in FIG. 1, the eccentric bush 2 comprises a collar element on one of its end sides, which collar element protrudes beyond the housing 3 in the radial direction. Furthermore, an eccentric insert 4 is provided which corotates with the eccentric bush 2 and is arranged between the axle 5 and the eccentric bush 2.

In order to increase an effective load-bearing surface area of the bushing 6, it is provided that a lubricant line 7 is let into the eccentric bush 2, in particular into a wall of the eccentric bush 2. As a result, a bore which would otherwise be necessary in the bushing 6 for an outlet opening which would be assigned to a lubricant line 7 which is let into the bushing 6 and the housing 3 can be dispensed with. The consequence is that the bushing 6 which is loaded during operation of the crusher can increase its effective load-bearing surface area and can thus counteract potential damage in the overload case. Here, the lubricant line 7 preferably runs substantially parallel to the axle 5. An outlet opening 10 of the lubricant line 7 which is let into the eccentric bush 2 is provided here, in particular, on an outer side of the eccentric bush 2, which outer side faces the bushing 6. On its outer side, the eccentric bush 2 preferably has a recess 8 for configuring a collecting point for the lubricant. The recess 8 and the outlet opening 10 together form, in particular, a hydrostatic pocket. The lubricant can be introduced via the lubricant line 7 into said collecting point with the aid of means for conveying the lubricant, for example a pump, with the result that a sufficient lubricant supply which is over as large a surface area as possible can be ensured for the bushing 6.

FIG. 2 shows the bearing 1 for a crusher in accordance with the exemplary embodiment of the present invention from FIG. 1 along a sectional plane which runs perpendicularly with respect to the axial direction. It is provided here, in particular, that the outlet opening 10 is spatially delimited as viewed in the circulating direction. It is provided here, in particular, that the outlet opening 10 is corotated during operation of the crusher and generates a lubricant film during the rotation of the eccentric bush 2 on the bushing 6. It is provided, in particular, that the outlet opening 10 is arranged in front of a load region of the crusher by a predefined angle φ_{A} as viewed in the rotational direction 9 of the eccentric bush 2. Here, the load region is preferably fixed by way of the region with the open annular gap, via which the material to be comminuted is arranged between the crusher casing and the crusher cone. In particular, a load region is that region on the bushing which is currently subjected to the highest loading during operation. As a result of the outlet opening 10 which is positioned in a leading manner as viewed in the rotational direction 9, it is possible in an advantageous way that fresh lubricant is constantly provided to the load region.

### LIST OF DESIGNATIONS

1 Bearing
2 Eccentric bush
3 Housing
4 Eccentric insert
5 Axle
6 Bushing
7 Lubricant line
8 Recess
9 Rotational direction
10 Outlet opening

1-10. (canceled)

11. A bearing for a crusher comprising:
a housing;
an eccentric bush that is mounted in the housing so as to be rotatable about an axle;
a bushing disposed between the housing and the eccentric bush; and
a lubricant line for supplying the bushing with lubricant that extends into the eccentric bush.

12. The bearing of claim 11 wherein the lubricant line extends along an axial direction within a wall of the eccentric bush.

13. The bearing of claim 11 wherein an outer side of the eccentric bush has an outlet opening for the lubricant line, wherein the outlet opening is directed onto the bushing.

14. The bearing of claim 13 wherein the outlet opening is spatially delimited in a circulating direction.

15. The bearing of claim 13 wherein the eccentric bush includes a recess in a region of the outlet opening for configuring a collecting point for the lubricant.

16. The bearing of claim 15 wherein the lubricant line extends along an axial direction within the eccentric bush, wherein the recess is delimited on both sides in the axial direction to throttle a supply of the lubricant.

17. The bearing of claim 13 wherein a position of the outlet opening is oriented such that the outlet opening is positioned in a leading manner at a predefined angle in a rotational direction of the bearing with respect to a load region of the crusher.

18. The bearing of claim 17 wherein the predefined angle is less than 200°.

19. The bearing of claim 17 wherein the predefined angle is less than 160°.

20. The bearing of claim 17 wherein the predefined angle is less than 120°.

21. The bearing of claim 11 comprising means for conveying the lubricant in the lubricant line.

22. A crusher comprising a bearing that includes a housing;
an eccentric bush that is mounted in the housing so as to be rotatable about an axle;
a bushing disposed between the housing and the eccentric bush; and
a lubricant line for supplying the bushing with lubricant that extends into the eccentric bush.
